(19) United States
(12) Patent Application Publication
(10) Pub. No.: US 2013/0166847 A1
(43) Pub. Date: Jun. 27, 2013

(54) INFORMATION PROCESSING APPARATUS AND CACHE CONTROL METHOD

(71) Applicant: Kazunari Kawamura, Akishima-shi (JP)

(72) Inventor: Kazunari Kawamura, Akishima-shi (JP)

(21) Appl. No.: 13/606,460

(22) Filed: Sep. 7, 2012

(30) Foreign Application Priority Data
Dec. 27, 2011 (JP) 2011-286065

(51) Int. Cl. G06F 12/08

(52) U.S. Cl. 711/129; 711/E12.022; 711/E12.023

(57) ABSTRACT

According to one embodiment, an apparatus includes a storage module, a cache module, and a changing module. The cache module is configured to use a first cache data storage region in a storage region of a first storage device as a cache of the storage module, and to manage cache management information includes position information indicating a position of the first cache data storage region. The changing module is configured to store cache data stored in the first cache data storage region in a second cache data storage region in a storage region of a second storage device when it is requested to use the second cache data storage region as the cache of the storage module, and to update the position information.

### CROSS-REFERENCE TO RELATED APPLICATIONS

This application is based upon and claims the benefit of priority from Japanese Patent Application No. 2011-286065, filed Dec. 27, 2011, the entire contents of which are incorporated herein by reference.

### FIELD

Embodiments described herein relate generally to an information processing apparatus and a cache control method, in which a storage device used as a cache device can be changed.

### BACKGROUND

In these times, interfaces which are comparatively low in price and quickly detachable, such as USB (Universal Serial Bus) 3.0, are becoming widespread, and usable as cache devices for reading and writing data from and in hard disks of low speed.

There is a demand for change of the cache device with the current cache effect maintained, when the user obtains a storage device which is expected to improve performance more than the existing cache device, such as a storage device which achieves higher access speed or larger capacity than that of the storage device used as the current cache device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an example of a system configuration of an information apparatus according to an embodiment.

FIG. 2 is an exemplary block diagram illustrating an example of a structure of a cache system of the information processing apparatus illustrated in FIG. 1.

FIG. 3 is an exemplary diagram illustrating an example of a structure of a cache information storage region.

FIG. 4 is an exemplary diagram illustrating an example of a structure of a cache management information storage region.

FIG. 5 is an exemplary diagram illustrating an example of a structure of cache management information identification information.

FIG. 6 is an exemplary diagram illustrating an example of data stored in the cache management information.

FIG. 7 is an exemplary diagram illustrating a state where a second USB flash device is connected to the cache system illustrated in FIG. 2.

FIG. 8 is an exemplary block diagram illustrating an example of a structure of management software.

FIG. 9 is an exemplary block diagram illustrating an example of a structure of a cache driver.

FIG. 10 is an exemplary flowchart illustrating an example of procedure performed when the cache device is changed from a first USB flash device to the second USB flash device.

FIG. 11 is an exemplary diagram illustrating an example of a state where the cache information storage region is formed in the second USB flash device.

FIG. 12 is an exemplary diagram illustrating a state where cache data which is stored in the cache data storage region of the first USB flash device is copied in the cache data storage region in the second USB flash device.

FIG. 13 is an exemplary diagram illustrating a state where the cache management information in a main memory is copied in a cache management information storage region in the second USB flash device.

FIG. 14 is an exemplary diagram illustrating a state where a cache data storage region start address in the cache management information is changed.

FIG. 15 is an exemplary diagram illustrating a state where the cache management information in the main memory is updated by cache management information in the cache management information storage region of the second USB flash device.

FIG. 16 is an exemplary diagram illustrating a state where a user region is expanded by using a region which has become available since the cache information storage region in the first USB flash device has been deleted.

### DETAILED DESCRIPTION

Various embodiments will be described hereinafter with reference to the accompanying drawings.

In general, according to one embodiment, an information processing apparatus includes a storage module, a cache module, and a changing module. The cache module is configured to use a first cache data storage region in a storage region of a first storage device as a cache of the storage module, and to manage cache management information comprising position information indicating a position of the first cache data storage region. The changing module is configured to perform a changing processing comprising processing of storing cache data stored in the first cache data storage region in a second cache data storage region in a storage region of a second storage device when it is requested to use the second cache data storage region as the cache of the storage module instead of the first cache data storage region, and processing of updating the position information such that the position information indicates a position of the second cache data storage region.

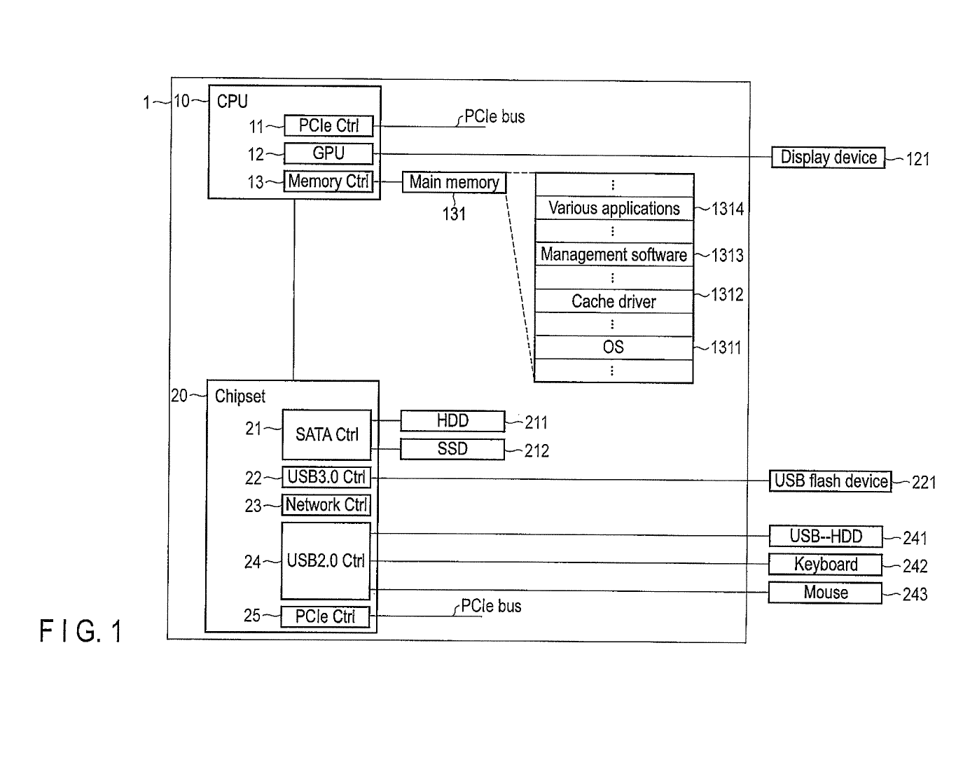

FIG. 1 is a diagram illustrating a system configuration of an information processing apparatus according to an embodiment. The information processing apparatus of the present embodiment is realized as a personal computer.

As illustrated in FIG. 1, the information processing apparatus 1 comprises a CPU (Central processing unit) 10, a chipset 20, a main memory 131, a hard disk drive (HDD) 211, and an SSD (Solid State Drive) 212, and the like.

The CPU 10 is a processor which controls operation of the information processing apparatus 1, and executes various programs which are loaded from the HDD 211 and the SSD 212 into the main memory 131. The various programs executed by the CPU 10 include an OS 1311 which performs resource management, and a cache driver 1312, management software 1313 and various application programs 1314 which operate under the OS 1311. The cache driver 1312 is aimed at increase in speed of access to the HDD 211, by using a first USB flash device 221, which has higher access speed than the HDD 211, as a cache of the HDD 211. The processing which is executed by the management software 1313 will be explained later.

The CPU 10 includes a PCI (Peripheral Component Interconnect) Express controller (PCIe Ctrl) 11, a GPU (Graphics Processing Unit) 12, and a memory controller 13.

The PCI Express controller 11 controls various peripheral devices which are connected to a PCI Express bus.

The GPU 12 is a display controller which controls a display device 121. The GPU 12 is equipped with an accelerator, which draws an image to be displayed by the various programs instead of the CPU 10.

The memory controller 13 controls memory interface, such as reading and writing of data from and in the main memory 131, and refreshment of the main memory 131.

The chipset 20 includes a Serial Advanced Technology Attachment (ATA) controller (SATA Ctrl) 21, a USB 3.0 controller (USB 3.0 Ctrl) 22, a network controller (Network Ctrl) 23, a USB 2.0 controller (USB 2.0 Ctrl) 24, and a PCI Express controller 25, etc.

The serial ATA controller 21 controls communication with the HDD 211 and the SSD 212.

The USB 3.0 controller 22 controls communication with a first USB flash device 221.

The USB 2.0 controller 24 controls communication with a USB HDD 241, a keyboard 242, and a mouse 243.

Next, cache processing performed by the cache driver 1312 will be explained hereinafter.

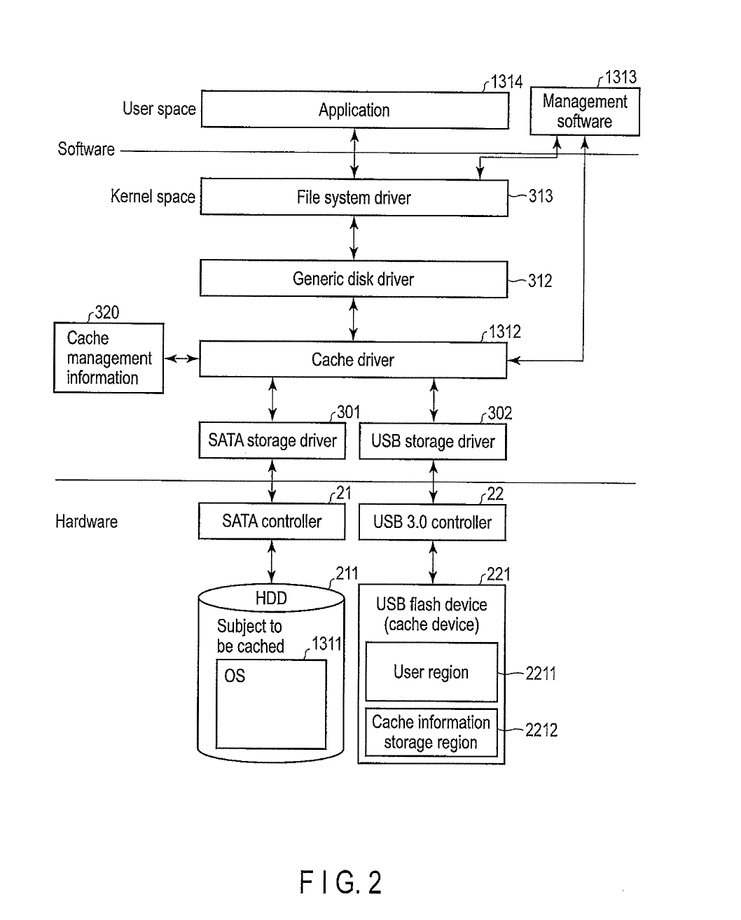

FIG. 2 is an example of a block diagram of a cache system.

The operating system (OS) 1311 is installed in the HDD 211. At least part of a storage region of the HDD 211 including a storage region in which the OS is stored is the subject of cashing. The cache driver 1312 uses the first USB flash device 221 as a cache of the HDD 211. The USB flash device 221 used as the cache is referred to as “cache device” hereinafter.

The storage region in the cache device 221 is divided into two regions, that is, a user region 2211 and a cache information storage region 2212.

The user region 2211 is a region which the user can use without restraint. The user region is a region in which data can be stored and deleted, like a general USB flash device.

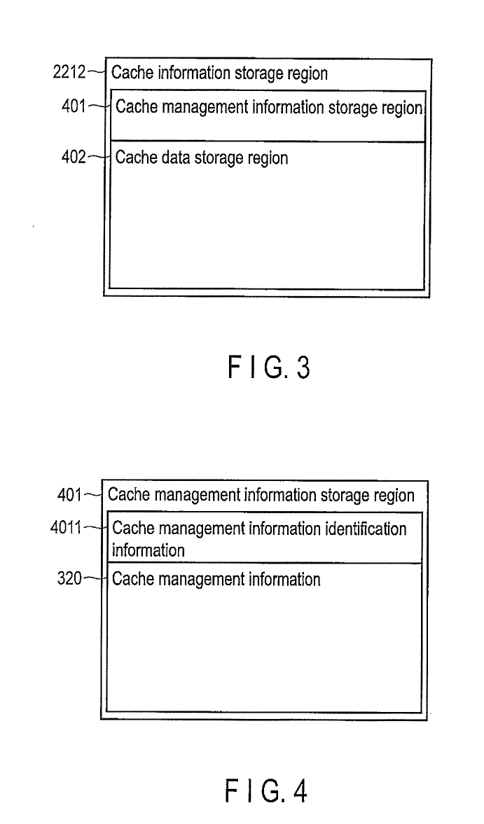

The cache information storage region 2212 will be explained hereinafter with reference to FIG. 3.

Software operates by being loaded into virtual memory (hereinafter referred to as “memory”) provided by the main memory 131 or the OS 1311 and executed by the CPU 10. The memory is divided into a kernel space in which the OS 1311 itself operates, and a user space in which general applications operate.

In the kernel space, a SATA storage driver 301 which controls the SATA controller, and a USB storage driver 302 which controls the USB 3.0 controller operate as modules of a layer that is closest to the hardware.

The cache driver 1312 operates in a layer upper than the SATA storage driver 301 and the USB storage driver 302. The cache driver 1312 determines hit/miss based on cache management information 320, when the cache driver 1312 receives a request to access the cached region from an upper generic disk driver 312. When the required data hits the cache, the cache driver 1312 accesses the cache device. When the required data misses the cache, the cache driver 1312 accesses a cached region. The cache driver 1312 also performs processing of moving data which is frequently accessed to the cache device. The cache driver 1312 reads cache management information from the cache device in startup, and copies the information in the memory. The cache driver 1312 performs cashing, while updating the cache management information in the memory during the system is operated. When the system is shut down, the cache driver 1312 stores the cache management information of the memory in the cache device.

A file system driver 313 operates in a layer upper than the generic disk driver 312. The file system driver 313 provides a file system to the user and the application. The file system driver 313 converts a request to access the file system to a request to access the disk, and transmits the access request to the generic disk driver 312.

The management software 1313 is an application which monitors the state of the cache system. The management software 1313 performs communication with the cache driver 1312 directly or through the file system, and proposes the obtained information to the user.

FIG. 3 is an example of a cache information storage region 2212 stored in the cache device. The cache information storage region 2212 is divided into two regions, that is, a cache management information storage region 401 and a cache data storage region 402. The cache data storage region 402 stores cache data. The cache management information storage region 401 stores information to manage the cache data in the cache data storage region 402.

FIG. 4 is a diagram illustrating an example of the cache management information storage region 401. The cache management information storage region 401 stores cache management information identification information 4011, and the cache management information 320.

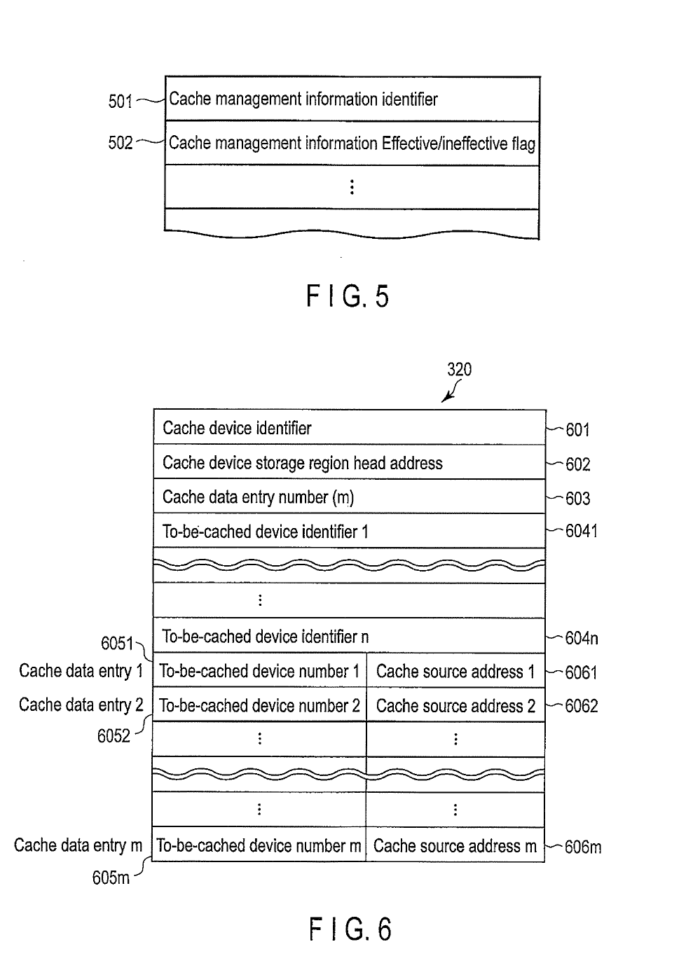

FIG. 5 is a diagram illustrating an example of the cache management information identification information 4011. The cache management information identification information 4011 at least stores a cache management information identifier 501 to identify the cache management information 320, and a cache management information effective/ineffective flag 502.

The cache management information identifier 501 is an identifier which is used for uniquely identifying the cache management information 320 stored in the cache device. When a cache device of a computer which uses a like cache system is connected to another computer, data is broken when the cache device is used by the latter computer, since the cached data is different between the computers. The identifier is required to prevent such a state. The cache management information identifier 501 is generated from information peculiar to the computer, such as the product ID of the operating system and the product ID of the mother board.

The cache management information identifier 501 is stored in the cache management information 320, and identification information which includes the cache management information identifier 501 is stored in the HDD 211 or the like. The identification information is preferably stored in a storage device included in the computer 1.

When operation is started, the cache driver 1312 compares the cache management information identifier in the computer with the cache management information identifier 501 in the USB flash device 221, and thereby determines whether the USB flash device 221 was used as the cache of the computer 1.

The cache management information effective/ineffective flag 502 is a flag which indicates whether the cache management information 320 is available or not. It is not always necessary to prepare the flag 502 as a separate flag, but the flag 502 may be combined with other information.

FIG. 6 is a diagram illustrating an example of the cache management information 320. The example of the cache management information 320 illustrated in FIG. 6 is an example of a cache system in which there is one cache device, the cache data storage region 402 is managed and divided into m regions, each of which has a specific size of S_{b}, and the maximum number of devices to be cached that can be simultaneously used is n.

A cache device identifier 601 is stored at the head of the cache management information 320. The cache device identifier 601 is an identifier to uniquely identify the cache device. For example, it is possible to use an identifier obtained by stringing the vendor name, model name, and serial number of the cache device, as the cache device identifier 601.

A cache data storage region head address 602 indicates a head address of the cache data storage region 402 in which the cache data illustrated in FIG. 3 is stored.

A cache data entry number (m) (m is an integer) 603 is the number of regions obtained by dividing the cache data storage region 402.

To-be-cached device identifiers 604l to 604n are also identifiers for uniquely identifying respective devices, like the cache device identifier 601. Information for n devices can be stored such that n devices to be cached can be simultaneously used.

A cache data entry is information which stores to-be-cached device numbers 605l to 605m in association with cache source addresses 6061 to 606m to be paired with each other, and stores the original position of the cached data.

The to-be-cached device numbers 6051 to 605m are places where the to-be-cached device identifiers 6041 to 604n are registered. The cache destination address is calculated based on the to-be-cached device number of the cache entry and the cache data storage region head address 602. Since the cache data storage region 402 is managed and divided into m regions, m entries can be stored. A cache data entry which is not used can be identified by putting a value “0” in the to-be-cached device number.

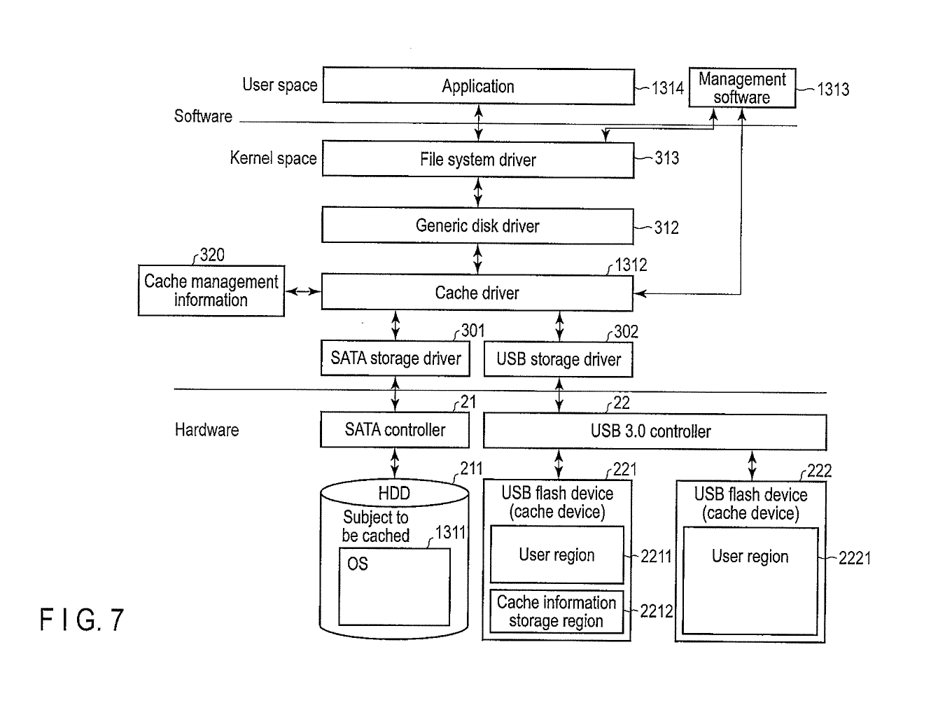

FIG. 7 illustrates a state where a second USB flash device is connected to the cache system of FIG. 2.

The management software 1313 compares performance of the first USB flash device, which is being used as the cache device, with performance of a second USB flash device 222. When the second USB flash device 222 has higher access speed than access speed of the first USB flash device 221, or has free space capacity larger than the capacity of the cache information storage region 2212 in the first USB flash device 221, higher effect as cache of the HDD 211 can be expected by changing the cache device from the first USB flash device 221 to the second USB flash device 222.

The present apparatus can change the cache device during system operation, by performing processing explained later using the management software 1313 and the cache driver 1312.

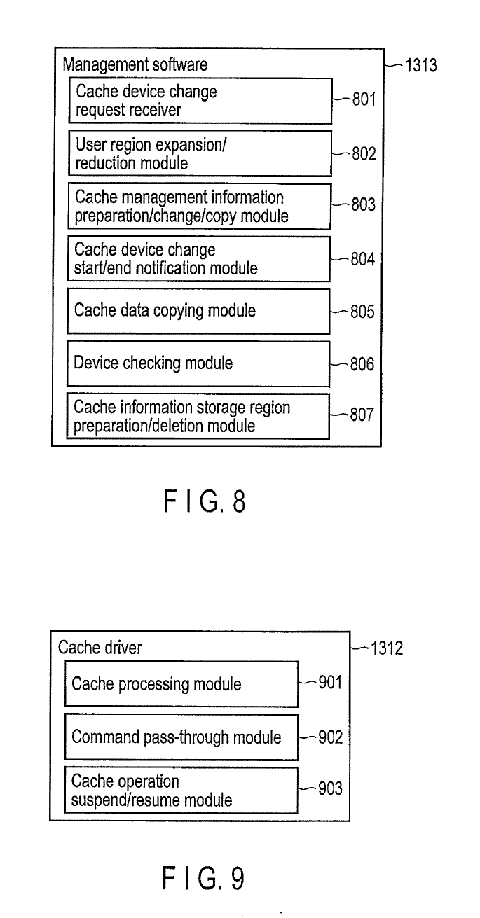

FIG. 8 is a block diagram illustrating a structure of the management software 1313. In addition to the above functions of the management software 1313 in the above cache system, the management software 1313 includes a cache device change request receiver 801, a user region expansion/reduction module 802, a cache management information preparation/change/copy module 803, a cache device change start/end notification module 804, a cache data copying module 805, a device checking module 806, and a cache information storage region preparation/deletion module 807.

The cache device change request receiver 801 receives a request to change the cache device from the user. The user designates a cache device which is to be newly used (new cache device).

The user region expansion/reduction module 802 expands and reduces the user region secured in the cache device. Since a file system exists in the user region, the user region expansion/reduction module 802 issues a request to change the size to the file system.

The cache management information preparation/change/copy module 803 operates the cache management information 320. The operation of the cache management information 320 includes operation for the cache management information identification information 4011. The cache management information preparation/change/copy module 803 issues a read/write command to the cache device, by using a command pass-through function of the cache driver 1312. Change of the capacity used as the cache means change of a size S_{c} of the cache information storage region 2212. In accordance with change of the size S_{c}, a size Sₘ of the cache management information storage region 401 and a size S_{d} of the cache data storage region 402 change. The value of the cache data entry number (m) changes in accordance with change of the size of the cache data storage region 402. For example, they can be calculated by the following expressions.

Cache management information storage region size Sₘ=((S_{c}/S_{b}×Sₑ+Sᵢ+S_{f})/S_{b}+1)×S_{b}

Cache data storage region size S_{d}=S_{c}−Sₘ

Cache data entry number m=S_{d}/S_{b}

Reference symbol Sᵢ represents the size of the cache management information identification information 4011, S_{f} represents the size from the cache device identifier 601 to the to-be-cached device identifier in the cache management information 320, Sₑ represents the size of one cache data entry, and “/” represents division of an integer (decimals are rounded off).

When the cache management information 320 is copied, it is necessary to consider increase/decrease of the number of entries. For example, when the free space capacity of the second USB flash device 222 is larger than the capacity of the cache information storage region 2212 in the first USB flash device 221 and the capacity of the cache data storage region 402 is increased, the cache management information preparation/change/copy module 803 adds an unused (new) entry to the cache management information storage region 401, in accordance with the increased capacity.

For example, when the free space capacity of the second USB flash device 222 is smaller than the capacity of the cache information storage region 2212 in the first USB flash device 221 and the capacity of the cache data storage region 402 decreases, the last entry is deleted from the cache management information storage region 401.

The cache device change start/end notification module 804 notifies the cache driver 1312 of start and end of processing of changing the cache device. When the cache driver 1312 receives a start notification from the cache device change start/end notification module 804, the cache driver 1312 stops operation of the cache by using a cache operation suspend module. Therefore, after the start notification, it is necessary to access the device, by using the command pass-through module of the cache driver 1312. When the cache driver 1312 receives an end notification from the cache device change start/end notification module 804, the cache driver 1312 resumes operation of the cache by using a cache operation suspend/resume module, and thus the devices can access the cache as usual.

The cache data copying module 805 prepares a cache data storage region 402 in a cache information storage region 2212 of the new cache device, and copies the cache data of the cache device which has been used until now in the new cache device, by using the command pass-through module of the cache driver 1312. It is necessary to consider change in the capacity which is used as the cache, in the same manner as copying of the cache management information 320.

The device checking module 806 checks whether the new cache device can actually be used as the cache device. The device checking module 806 measures the performance of the new cache device, and checks that the new cache device has more improved performance than the cache device being used. The device checking module 806 also checks whether the new cache device has free space capacity enough to prepare cache information storage region 2212 of the capacity designated by the user. When the new cache device does not have enough free space capacity, the device checking module 806 checks the file system of the user region, and checks whether the user region can be reduced, and whether a necessary free space capacity can be secured by reducing the user region.

The cache information storage region preparation/deletion module 807 prepares cache information storage region 2212 of the capacity designated by the user in a free space of the new cache device, and deletes the cache information storage region 2212 of the device which is not the cache device any longer.

FIG. 9 is a block diagram illustrating an example of a structure of the cache driver 1312. The cache driver 1312 includes a cache processing module 901 which executes the function of the cache driver 1312 of the above cache system, a command pass-through module 902, and the cache operation suspend/resume module 903.

The cache operation suspend/resume module 903 notifies the cache processing module 901 of start and end of processing of changing the cache device, in response to a cache device change start/end notification from the management software 1313. When the cache processing module 901 receives a cache device change start notification, the cache processing module 901 performs processing to suspend the cache operation. Thereafter, the cache processing module 901 holds requests issued from the generic disk driver 312 of the upper layer, without processing the requests. When there are already any requests which are being processed, the cache processing module 901 executes the requests which are being processed. When all the requests being processed are finished, the cache processing module 901 transmits a cache device change notification receipt to the management software 1313. When the cache processing module 901 receives a cache device change end notification, the cache processing module 901 starts cache operation by using the new cache device. The cache processing module 901 successively processes all the suspended requests which are issued from the generic disk driver 312 and held, and starts reception of requests from the all-purpose disk driver.

The command pass-through module 902 processes requests which are issued by the management software 1313 to the devices while the cache operation is suspended.

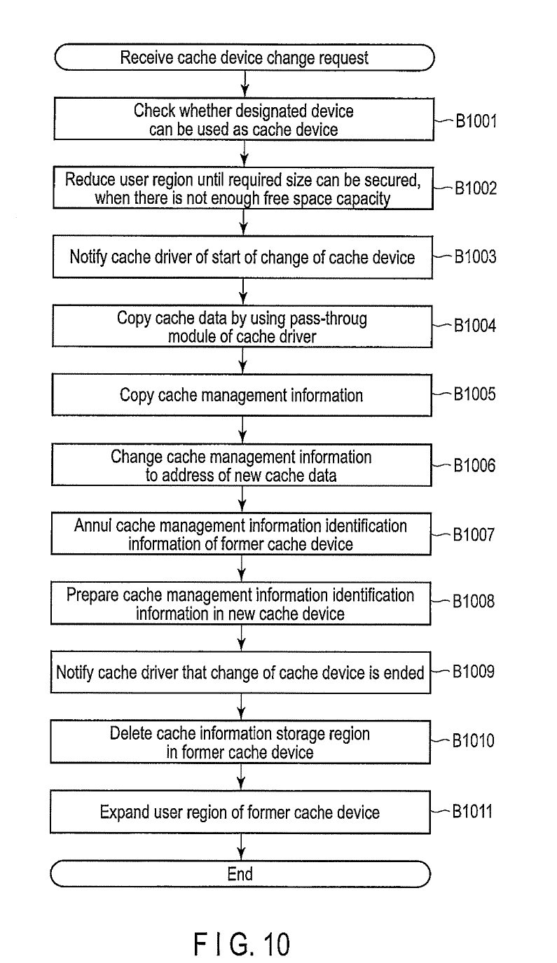

FIG. 10 is a flowchart of a procedure performed when the cache device is changed from the first USB flash device 221 to the second USB flash device 222.

The change processing is started by user's instructing the management software 1313 to change the cache device. The user designates a device to be used as the cache device, and a capacity to be used as the cache.

The device checking module 806 checks whether the second USB flash device 222 designated by the user can be used as the cache device (Step B1001).

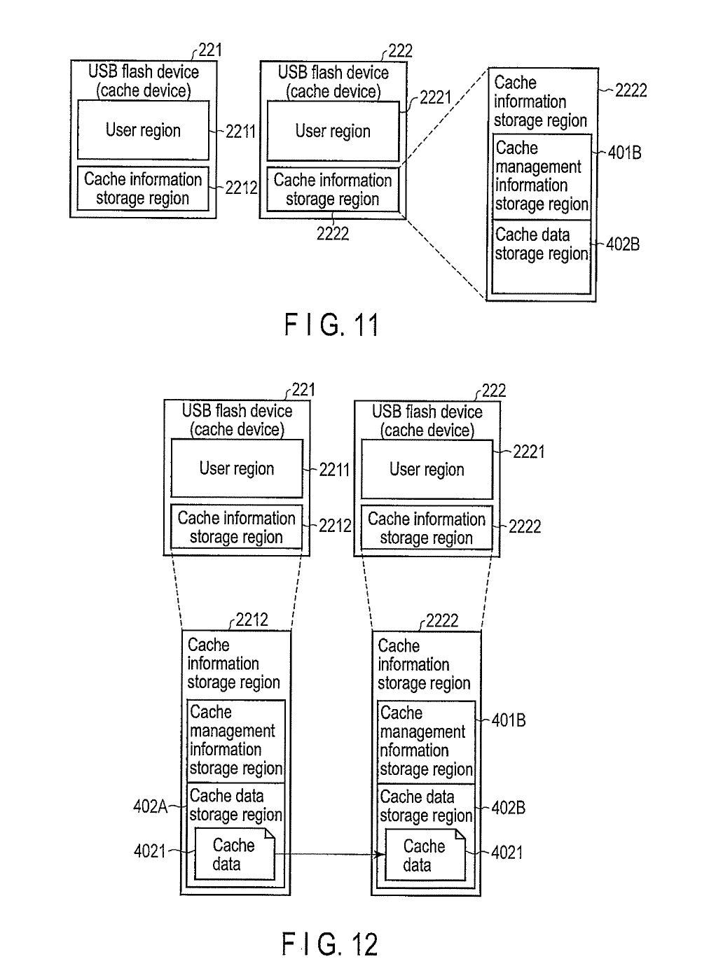

When the device checking module 806 determines that the second USB flash device 222 does not have enough free space capacity to prepare cache information storage region 2212, the user region expansion/reduction module 802 reduces the user region in the storage region of the second USB flash device 222, and secures a free space capacity (Step B1002). In addition, as illustrated in FIG. 11, the cache information storage region preparation/deletion module 807 prepares a cache information storage region 2222 in the second USB flash device 222. A cache management information storage region 401B and a cache data storage region 402B are secured in the cache information storage region 2222.

The cache device change start/end notification module 804 of the management software 1313 notifies the cache processing module 901 of start of change of the cache device (Step B1003). In response to the notification, the cache operation suspend/resume module 903 of the cache driver 1312 executes processing of suspending the operation of the cache.

As illustrated in FIG. 12, the cache data copying module 805 of the management software 1313 copies cache data 4021, which is cached in cache data storage region 402A of the first USB flash device 221, in the cache data storage region 402B of the second USB flash device 222 (Step B1004).

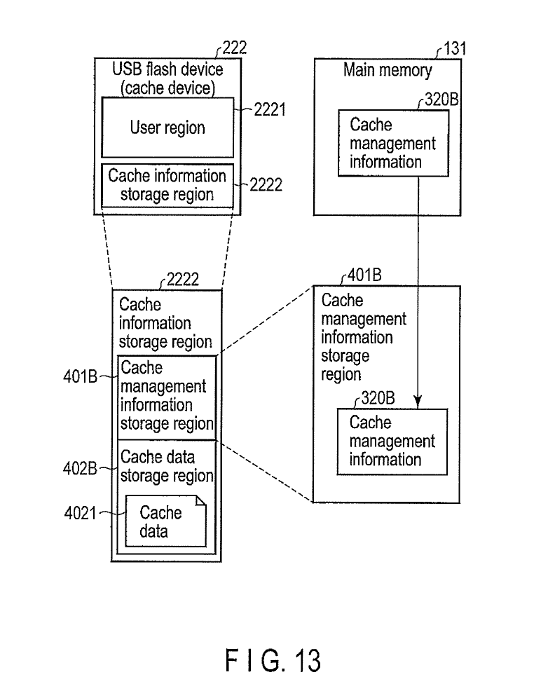

As illustrated in FIG. 13, the cache management information preparation/change/copy module 803 of the management software 1313 copies cache management information 320B of the main memory 131 in the cache management information storage region 401B of the second USB flash device 222 (Step B1005).

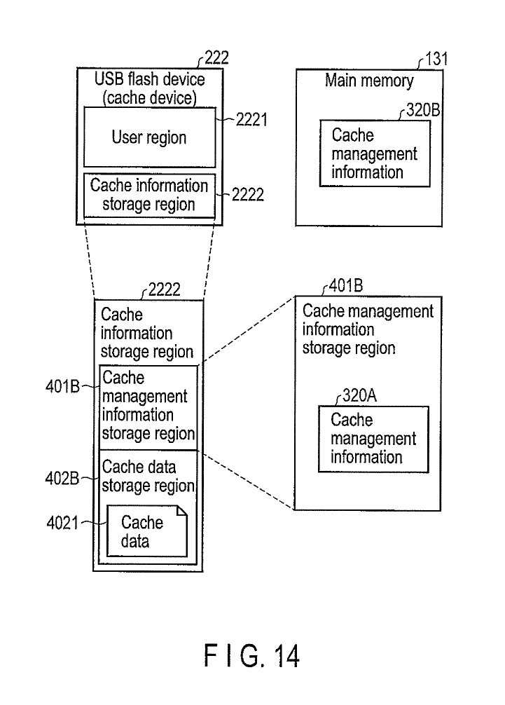

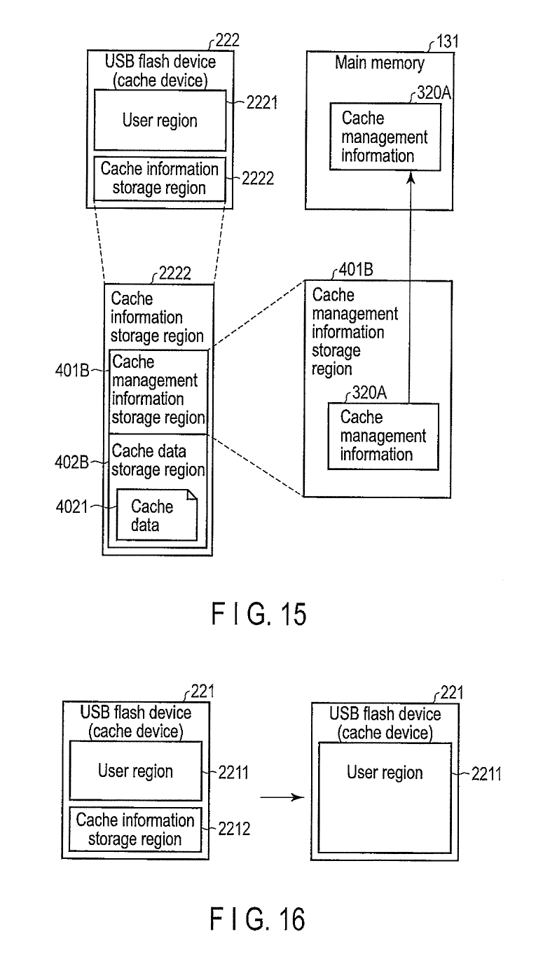

The cache management information preparation/change/copy module 803 of the management software 1313 changes the cache data storage region start address included in the cache management information 320B of the second USB flash device 222 to a head address of the cache data storage region 402 of the second USB flash device 222 (Step B1006). As illustrated in FIG. 14, cache management information obtained by changing the cache data storage region start address is referred to as cache management information 320A. As illustrated in FIG. 15, the cache management information preparation/change/copy module 803 updates the cache management information 320A in the main memory 131 by the cache management information 320A in the cache management information storage region 401B of the second USB flash device 222.

The cache management information preparation/change/copy module 803 of the management software 1313 changes the cache management information effective/ineffective flag 502 included in the cache management information identification information 4011 in the first USE flash device 221 to a value which indicates that the information is ineffective (Step B1007).

The cache management information preparation/change/copy module 803 of the management software 1313 generates cache management information identification information 4011 which corresponds to the second USB flash device 222, in the cache management information storage region 401 in the second USB flash device 222 (Step B1008). A cache management information effective/ineffective flag 502 which is included in the cache management information identification information 4011 in the second USB flash device 222 is changed to a value which indicates that the information is effective.

The cache device change start/end notification module 804 of the management software 1313 notifies the cache driver 1312 that change of the cache device is ended (Step B1009). The cache operation suspend/resume module 903 of the cache driver 1312 resumes cache operation, using the second USB flash device 222 as the cache device.

The cache information storage region preparation/deletion module 807 of the management software 1313 deletes data stored in the cache information storage region 2212 in the first USB flash device 221 (Step B1010).

As illustrated in FIG. 16, the user region expansion/reduction module 802 of the management software 1313 expands the user region, by using a region which has become available since the cache information storage region 2212 in the first USB flash device 221 has been deleted (Step B1011).

As described above, it is possible to change the cache device, while the current cache effect is maintained, by performing the cache device change processing.

Although USB flash device are used as cache devices in the above embodiment, the same processing can be performed also in the case of using SSDs connected through an SATA as cache devices.

Although all the cache operations are stopped during the processing of changing the cache device in the above embodiment, read cache operation using the first USB flash device may be performed.

Although all the requests issued from the generic disk driver are blocked during change of the cache device in the above embodiment, both the new and the former cache devices may be used during the change to reduce the blocked region as small as possible, such that ordinary cashing processing is not prevented.

In addition, performance of a new device which is connected to the system may be automatically measured, and the system may encourage the user to change the cache device when performance of the new device is better than the current cache device.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage module;
a cache module configured to use a first cache data storage region in a storage region of a first storage device as a cache of the storage module, and to manage cache management information comprising position information indicating a position of the first cache data storage region; and
a changing module configured to perform a changing processing comprising processing of storing cache data stored in the first cache data storage region in a second cache data storage region in a storage region of a second storage device when it is requested to use the second cache data storage region as the cache of the storage module instead of the first cache data storage region, and processing of updating the position information such that the position information indicates a position of the second cache data storage region.

2. The apparatus of claim 1, further comprising:
a setting module configured to set a size of the second cache data storage region in accordance with a free space capacity of the storage region of the second storage device when it is requested to use the second cache data storage region as the cache of the storage module instead of the first cache data storage region.

3. The apparatus of claim 2, wherein
the setting module is configured to set the size of the second cache data storage region to be larger than a size of the first cache data storage region, when the free space capacity of the storage region of the second storage device is larger than the size of the first cache data storage region.

4. The apparatus of claim 2, wherein
the changing module is configured to store, in the second cache data storage region, a part of the cache data stored in the first cache data storage region, when the free space capacity of the storage region of the second storage device is smaller than a size of the first cache data storage region.

5. The apparatus of claim 1, further comprising:
a cache controller configured to prohibit the cache module from using the first cache data storage region and the second cache data storage region as the cache of the storage module from start to end of the changing processing.

6. The apparatus of claim 1, further comprising:
a cache controller configured to allow the cache module to use the first cache data storage region as a read cache of the storage module, and to prohibit the cache module from using the first cache data storage region and the second cache data storage region as a write cache of the storage module, from start to end of the changing processing.

7. The apparatus of claim 1, further comprising:
a deleting module configured to delete the cache data stored in the first cache data storage region, after the cache data stored in the first cache data storage region is stored in the second cache data storage region.

8. The apparatus of claim 1, wherein
the position information comprises a head address of the first cache data storage region or a head address of the second cache data storage region, and
the cache management information comprises size information which indicates a size of the first cache data storage region or a size of the second cache data storage region.

9. A cache control method comprising:
managing cache management information comprising position information indicating a position of a first cache data storage region in a storage region of a first storage device;
using the first cache data storage region as a cache of a storage module;
performing changing processing comprising processing of storing cache data stored in the first cache data storage region in a second cache data storage region in a storage region of a second storage device, and processing of updating the position information such that the position information indicates a position of the second cache data storage region, when it is requested to use the second cache data storage region as the cache of the storage module instead of the first cache data storage region.

10. The method of claim 9, wherein
a size of the second cache data storage region is set in accordance with a free space capacity of the storage region of the second storage device, when it is requested to use the second cache data storage region as the cache of the storage module instead of the first cache data storage region.

11. The method of claim 10, wherein
the size of the second cache data storage region is set to be larger than a size of the first cache data storage region, when the free space capacity of the storage region of the second storage device is larger than the size of the first cache data storage region.

12. The method of claim 10, wherein
a part of the cache data stored in the first cache data storage region is stored in the second cache data storage region, when the free space capacity of the storage region of the second storage device is smaller than a size of the first cache data storage region.

13. The method of claim 9, wherein
using the first cache data storage region and the second cache data storage region as the cache of the storage module is prohibited from start to end of the changing processing.

14. The method of claim 9, wherein
using the first cache data storage region as a read cache of the storage module is allowed, and using the first cache data storage region and the second cache data storage region as a write cache of the storage module is prohibited, from start to end of the changing processing.

15. The method of claim 9, wherein
the cache data stored in the first cache data storage region is deleted, after the cache data stored in the first cache data storage region is stored in the second cache data storage region.

16. The method of claim 9, wherein
the position information comprises a head address of the first cache data storage region or a head address of the second cache data storage region, and
the cache management information comprises size information which indicates a size of the first cache data storage region or a size of the second cache data storage region.
